(19) United States
(12) Patent Application Publication
(10) Pub. No.: US 2026/0177955 A1
(43) Pub. Date: Jun. 25, 2026

(54) FIXING UNIT

(71) Applicant: CANON KABUSHIKI KAISHA, Tokyo (JP)

(72) Inventors: YASUMASA MATAYOSHI, Shizuoka (JP); TERUHIKO NAMIKI, Shizuoka (JP); TAKAO KAWAZU, Shizuoka (JP)

(21) Appl. No.: 19/408,628

(22) Filed: Dec. 4, 2025

(30) Foreign Application Priority Data
Dec. 19, 2024 (JP) 2024-224574

(51) Int. Cl. G03G 15/20; G03G 15/00; G03G 21/16

(52) U.S. Cl. CPC G03G 15/2053; G03G 15/2064; G03G 15/80; G03G 21/1647; G03G 2215/2035

(57) ABSTRACT

A fixing unit includes a fixing belt, a heater including a substrate, a heating resistor, and an electrode, a holder, and a power supply connector configured to supply electrical power to the heater, the power supply connector including a contact configured to come into contact with the electrode, and a housing configured to accommodate the contact. The holder is integrally formed with a retention portion configured to prevent the power supply connector from disengaging from the heater. The contact includes a first portion configured to come into contact with the electrode, and a second portion configured to clamp the heater and the holder in conjunction with the first portion. When viewed in the longitudinal direction, the contact has a rectangular shape that is open on one side.

### BACKGROUND

### Field of the Technology

This disclosure relates to a fixing unit that is mounted to an image forming apparatus of an electrophotographic system.

### Description of the Related Art

A fixing unit described in Japanese Patent Laid Open No. H11-345680 includes a heating unit provided with a heater that heats an inner surface of a belt, and a pressure roller that forms a nip portion with the heater via a fixing film, and, thereby, fixes toner on a recording material. In the heating unit, a power supply connector is disposed, and a contact member that engages with an electrode portion connected to a current-carrying heating resistor layer of the heater is disposed in the power supply connector.

### SUMMARY

According to one aspect of the present disclosure, a fixing unit includes a fixing belt which is tubular, a heater including a substrate having a plate shape, a heating resistor disposed on the substrate, and an electrode electrically connected to the heating resistor and disposed at an end portion in a longitudinal direction of the substrate, the heater being disposed within an inner space of the fixing belt, a holder disposed within the inner space of the fixing belt and configured to hold the heater along the longitudinal direction thereof, and a power supply connector configured to supply electrical power to the heater, the power supply connector including a contact configured to come into contact with the electrode, the contact having conductivity, and a housing configured to accommodate the contact. The fixing unit is configured to fix a toner image formed on a recording material onto the recording material with heat of the heater via the fixing belt. The holder is integrally formed with a retention portion configured to prevent the power supply connector from disengaging from the heater. The contact includes a first portion configured to come into contact with the electrode, and a second portion configured to clamp the heater and the holder in conjunction with the first portion. When viewed in the longitudinal direction, the contact has a rectangular shape that is open on one side.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an image forming apparatus according to Example 1.

FIG. 2 is a cross-sectional view illustrating a fixing unit according to Example 1.

FIG. 3 is a cross-sectional view illustrating the fixing unit according to Example 1.

FIG. 4 is an exploded perspective view illustrating the fixing unit according to Example 1.

FIG. 5 is a top view illustrating a holder according to Example 1.

FIG. 6 is an exploded perspective view illustrating the holder, temperature sensors, urging members, and a stay according to Example 1.

FIG. 7 is a bottom view illustrating a heater, the holder, and a belt according to Example 1.

FIG. 8 is a bottom view illustrating the heater according to Example 1.

FIG. 9A is a perspective view illustrating a state immediately before a connector according to Example 1 is mounted into the holder.

FIG. 9B is a perspective view illustrating a state in which the connector has been mounted into the holder.

FIG. 10 is a cross-sectional view illustrating a cross-section taken along a plane perpendicular to a Y direction of the holder and a contact according to Example 1.

FIG. 11A is a cross-sectional view illustrating a cross-section taken long a plane perpendicular to a Z direction of a holder and a contact according to Example 2.

FIG. 11B is a cross-sectional view illustrating a cross-section taken along a plane perpendicular to the Y direction of the holder and the contact according to Example 2.

### DESCRIPTION OF THE EMBODIMENTS

Hereinafter, an embodiment of this disclosure will be described based on drawings. To be noted, dimensions, materials, shapes, relative arrangement, and the like of constituent components described in each Example described below may be appropriately modified in accordance with configurations and various conditions of apparatuses to which this disclosure is applied. Accordingly, unless otherwise specifically stated, the scope of this disclosure is not limited to Examples described herein.

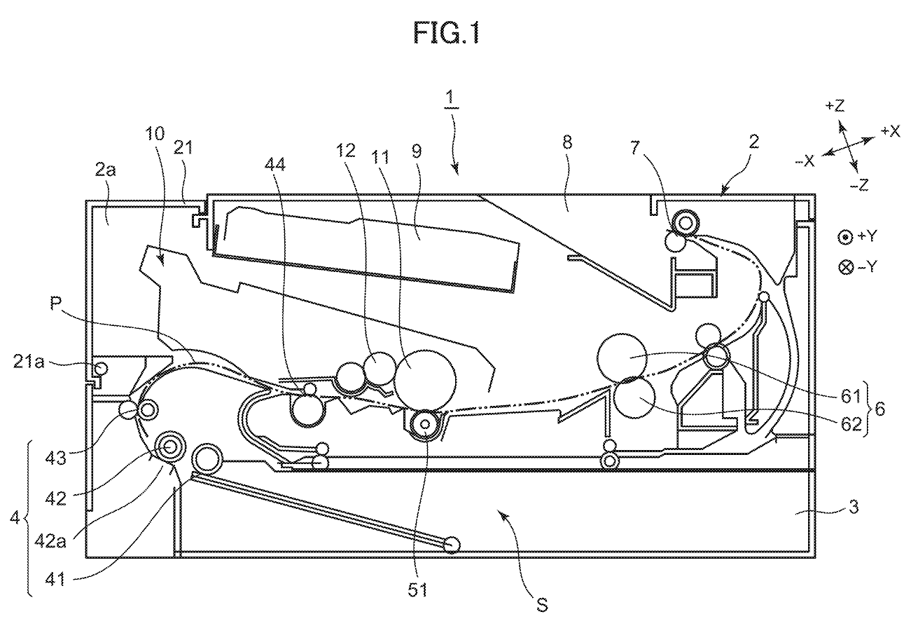

FIG. 1 is a cross-sectional view illustrating an image forming apparatus 1 of an electrophotographic system to which a fixing unit 6 in this Example is applied. To be noted, in the following description, as illustrated in FIG. 1, a nip direction in a nip portion np1 of the fixing unit 6, described below, is referred to as an Z direction. A direction intersecting the Z direction is referred to as a Y direction. The Y direction is a direction parallel to a rotational axis direction of a pressurizing rotary member 62, described below. A direction intersecting both the Z and Y directions is referred to as a X direction. The X direction is a direction parallel to a direction in which a heating unit 61, described below, conveys a recording material positioned at the nip portion. The X and Y directions are preferably a horizontal direction. In addition, the X, Y, and Z directions preferably intersect perpendicularly to each other. In addition, as necessary, arrows X, Y, and Z directions illustrated in each diagram are respectively referred to as +X, +Y, and +Z directions, and the opposite directions are respectively referred to as -X, -Y, and -Z directions. In the following description, a direction in which a sheet S, serving as the recording material, is conveyed at the nip portion np1, described below, is referred to as a recording material conveyance direction (+X direction). In addition, the rotational axis direction of the pressurizing rotary member 62, described below, is referred to as an axial direction. In the axial direction, a direction from a transmission member 617b to a transmission member 617a, described below, is referred to as a first axial direction (+Y direction). In the axial direction, a direction opposite to the first axial direction is referred to as a second axial direction (-Y direction). The Y direction is also a longitudinal direction of the heating unit 61. In addition, the Y direction is a generatrix direction of a belt 614.

### Example 1

### Configuration of Image Forming Apparatus

Using FIG. 1, a configuration of the image forming apparatus 1 according to Example 1 will be described. The image forming apparatus 1 includes an apparatus body 2, a process cartridge 10, and the fixing unit 6. The process cartridge 10 is detachably attached with respect to the apparatus body 2. The fixing unit 6 is detachably attached with respect to the apparatus body 2. It can also be said that the fixing unit 6 is mounted with respect to the apparatus body 2. To be noted, the fixing unit 6 may be attached in a non-detachable manner.

The apparatus body 2 includes a sheet feed tray 3, a sheet feeding unit 4, a conveyance path P, a transfer roller 51, a sheet discharge unit 7, a sheet discharge tray 8, a laser scanner 9, and an opening/closing door 21. The process cartridge 10 includes a photosensitive drum 11, and a developing roller 12, serving as a developer bearing member.

In addition, the process cartridge 10 stores developer inside. The opening/closing door 21 is pivotably supported around a pivot shaft 21a as a center, and is configured to move between a closed position closing an opening portion 2a and an open position opening the opening portion 2a. In a case where the opening/closing door 21 is positioned at the open position at which the opening portion 2a is opened, it is possible to attach and detach the process cartridge 10 with respect to the apparatus body 2 via the opening portion 2a.

The sheet feeding unit 4 is constituted by a sheet feed roller 41, a separation roller 42, a separation pad 42a, and a conveyance roller pair 43. Based on a print start signal, the sheet S stored in the sheet feed tray 3 is sent to the conveyance path P by the sheet feeding unit 4, and is conveyed via a registration roller pair 44 toward the transfer roller 51.

When the sheet S is conveyed to a predetermined position, an image formation start signal is transmitted, and an image formation process is started. The photosensitive drum 11, which is rotatably driven by a drive source (motor), not shown, is uniformly charged to a predetermined electrical potential by a charging means, not shown. With respect to a surface of the photosensitive drum 11 which has been charged, exposure is performed by the laser scanner 9 based on image information, and an electrostatic latent image in which a charge is removed from exposure areas is formed. The toner within the process cartridge 10 is borne by the developing roller 12, and is supplied to the photosensitive drum 11 in accordance with the electrostatic latent image; thereby, the latent image is developed. Thereby, the latent image is visualized on the photosensitive drum 11 as a toner image.

The transfer roller 51 is arranged to face the photosensitive drum 11 which the process cartridge 10 includes. When the sheet S, conveyed by the registration roller pair 44, passes through a nip portion of the photosensitive drum 11 and the transfer roller 51, voltage is applied to the transfer roller 51 from the apparatus body 2, and the toner image on the photosensitive drum 11 is transferred onto the sheet S as an unfixed image. Thereafter, the sheet S onto which the toner image has been transferred is conveyed to the fixing unit 6 equipped with the heating unit 61 and the pressurizing rotary member 62. The fixing unit 6 is a fixing unit that fixes the toner image (developer image) onto the recording material. When the sheet S passes through the nip portion of the heating unit 61 and the pressurizing rotary member 62, the unfixed image transferred onto the sheet S is heated and pressurized, and is fixed onto a surface of the sheet S. The sheet S onto which the toner image has been fixed is discharged via the sheet discharge unit 7 to the sheet discharge tray 8.

### Configuration of Fixing Unit

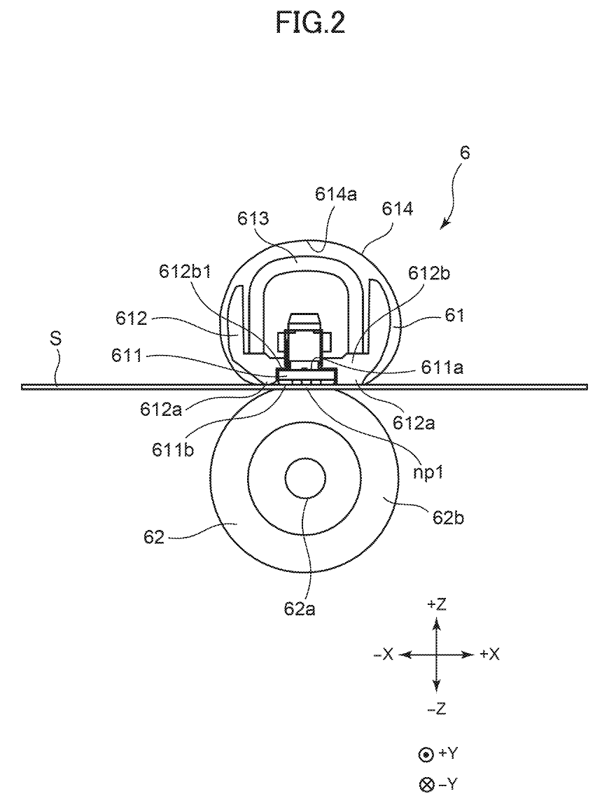

Next, a configuration of the fixing unit 6 will be described. FIG. 2 is a cross-sectional view illustrating the fixing unit 6. As illustrated in FIG. 2, the heating unit 61 includes a heater 611, a holder 612, a stay 613, and the belt 614 (also referred to as a fixing film), serving as a fixing belt. The heater 611 is disposed in an inner space of the belt 614, and heats the belt 614. The heater 611 extends in the generatrix direction of the belt 614 (Y direction), and a configuration of the heater 611 has a plate shape. The heater 611 includes a first surface 611a and a second surface 611b on a side opposite to the first surface 611a, and the first surface 611a is held by the holder 612. The holder 612 holds the heater 611 along the longitudinal direction (Y direction) thereof.

The holder 612 is fabricated from a heat resistant resin such as polyphenylene sulfide (PPS) or liquid crystal polymer, and includes a guide surface 612a and a support wall 612b. The guide surface 612a guides the belt 614 by coming into contact with an inner circumferential surface 614a of the belt 614, and the support wall 612b includes a support surface 612b1 that supports the heater 611. The support surface 612b1 of the support wall 612b comes into contact with the first surface 611a of the heater 611. The stay 613 is a member that supports the holder 612, and is formed by bending a plate material possessing higher stiffness than the holder 612, such as a steel plate having a thickness of 1.6 millimeters (mm), into a substantially U-shaped configuration.

The belt 614 is an endless belt formed in a tubular configuration, and possesses heat resistance and flexibility; for example, the belt 614 is constituted by a metal sleeve, such as stainless steel, coated with fluororesin, or a laminate of polyimide resin, silicone rubber, fluororesin, and the like. The heater 611, the holder 612, and the stay 613 are arranged in the inner space of the belt 614, and the belt 614 is configured to rotate around these members. The inner circumferential surface 614a of the belt 614 comes into contact with the second surface 611b of the heater 611.

The pressurizing rotary member (pressure roller) 62 includes a metallic shaft 62a and a roller 62b formed of an elastic substance covering the shaft 62a, and is pressed against the heater 611 via the belt 614. By clamping the belt 614 with the heater 611, the pressurizing rotary member 62 forms the nip portion np1 for heating and pressurizing the sheet S through nipping. In other words, it can be said that the pressurizing rotary member (pressure roller) 62 forms the nip portion np1 in conjunction with the heater 611 via the belt 614. That is, the pressurizing rotary member 62 heats and pressurizes the sheet S in conjunction with the heater 611 at the nip portion np1.

The pressurizing rotary member 62 is configured to rotate when a driving force from a drive source, which the image forming apparatus 1 includes, is transmitted. When the pressurizing rotary member 62 rotates, the belt 614 is rotatably driven. When the sheet S, onto which the toner image has been transferred, is conveyed between the pressurizing rotary member 62 and the belt 614 that is heated, the toner image is thermally fixed.

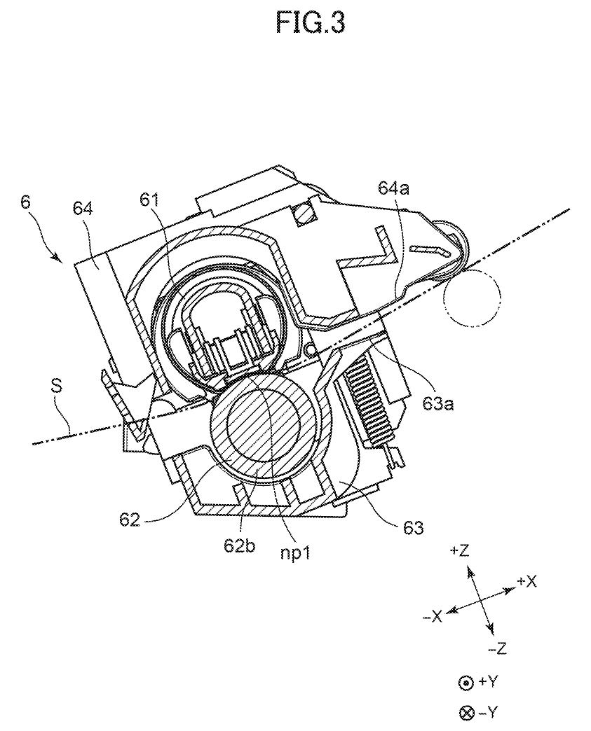

Next, using FIG. 3, a frame configuration of the fixing unit 6 will be described. FIG. 3 is a cross-sectional view illustrating the fixing unit 6. The fixing unit 6 includes an upper frame 64 and a lower frame 63. To be noted, the lower and upper frames 63 and 64 can also be respectively referred to as a first frame and a second frame. The lower frame 63 is a frame that supports the heating unit 61 and the pressurizing rotary member 62. The upper frame 64 is positioned on top of the lower frame 63, and covers the heating unit 61. The lower and upper frames 63 and 64 are resin members formed from a non-electrically conductive molded member (resin member). The upper frame 64 includes an upper guide surface 64a disposed further downstream in the recording material conveyance direction (+X direction) than the heating unit 61. The upper guide surface 64a guides an upper surface of the sheet S that is conveyed in the recording material conveyance direction. The lower frame 63 includes a lower guide surface 63a disposed further downstream in the recording material conveyance direction than the heating unit 61. The lower guide surface 63a guides a lower surface of the sheet S that is conveyed in the recording material conveyance direction.

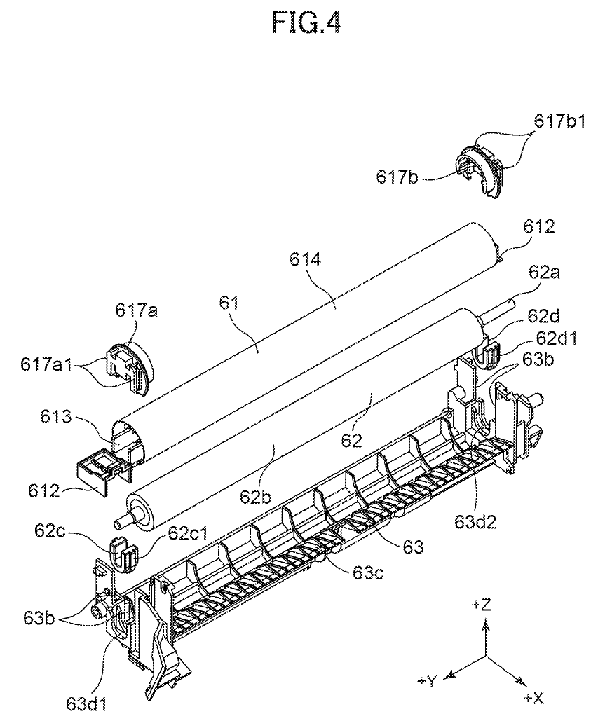

Next, using FIG. 4, a configuration of the lower frame 63 that supports the pressurizing rotary member 62 will be described. FIG. 4 is an exploded perspective view illustrating the fixing unit 6. The lower frame 63 includes rails 63b at each end portion in the first and second axial directions. The rails 63b extend in the vertical direction, and support the holder 612 in a manner allowing for vertical movement. Each of the two rails 63b is disposed in opposition to the other in the axial direction. The rails 63b engage with groove portions 617a1 and 617b1 respectively disposed in the transmission members 617a and 617b.

The fixing unit 6 includes bearings 62c and 62d. End portions in the first and second axial directions of the shaft 62a are respectively supported by the bearings 62c and 62d. The bearing 62c includes a projecting portion 62c1, and is positioned when the projecting portion 62c1 is fitted into a concave portion 63d1 disposed in the lower frame 63. Similarly, the bearing 62d includes a projecting portion 62d1, and is positioned when the projecting portion 62d1 is fitted into a concave portion 63d2 disposed in the lower frame 63. To be noted, the bearing 62c possesses electrical conductivity. To be noted, in this configuration, the projecting portions 62c1 and 62d1 are disposed in the bearings 62c and 62d, and the concave portions 63d1 and 63d2 are disposed in the lower frame 63; however, the projecting-concave relationship may be reversed. In addition, means for securing the bearings 62c and 62d to the lower frame 63 are not limited to the projecting-concave configuration.

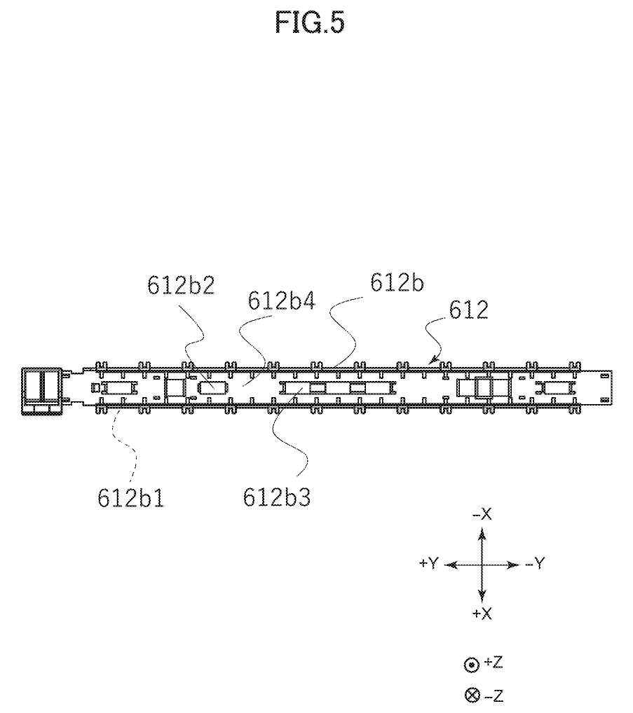

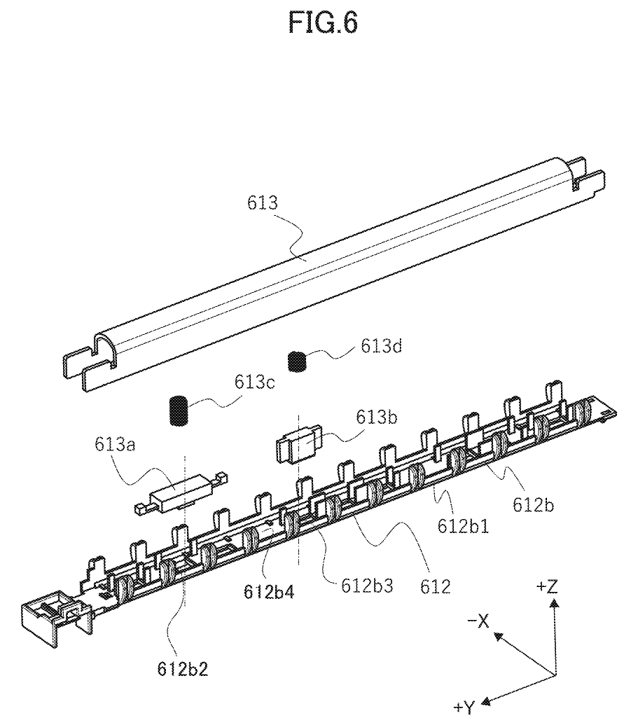

FIG. 5 is a top view illustrating the holder 612. FIG. 5 is a diagram in which the holder 612 is viewed in the -Z direction. FIG. 6 is an exploded perspective view illustrating the holder 612, temperature sensors 613a and 613b, urging members 613c and 613d, and the stay 613. As illustrated in FIG. 5, the supporting wall 612b of the holder 612 include a plurality of holes 612b2 and 612b3.

As illustrated in FIG. 6, the temperature sensors 613a and 613b are disposed to face a rear surface 612b4, which is on the opposite side of the supporting surface 612b1 of the holder 612. The temperature sensors 613a and 613b come into contact with the first surface 611a of the heater 611 through the holes 612b2 and 612b3. The temperature sensors 613a and 613b are pressed against the first surface 611a (refer to FIG. 2) of the heater 611 by the urging members 613c and 613d disposed between the stay 613 and the temperature sensors 613a and 613b. The temperature sensor 613a is positioned on one side of end portions in the longitudinal direction of the holder 612.

The temperature sensor 613b is positioned on the one side with respect to a center in the longitudinal direction (Y direction) of the holder 612. The temperature sensors 613a and 613b are thermistors in this Example, but may also be other temperature sensors such as thermostats. The urging members are coil springs in this Example, but may also be other urging members.

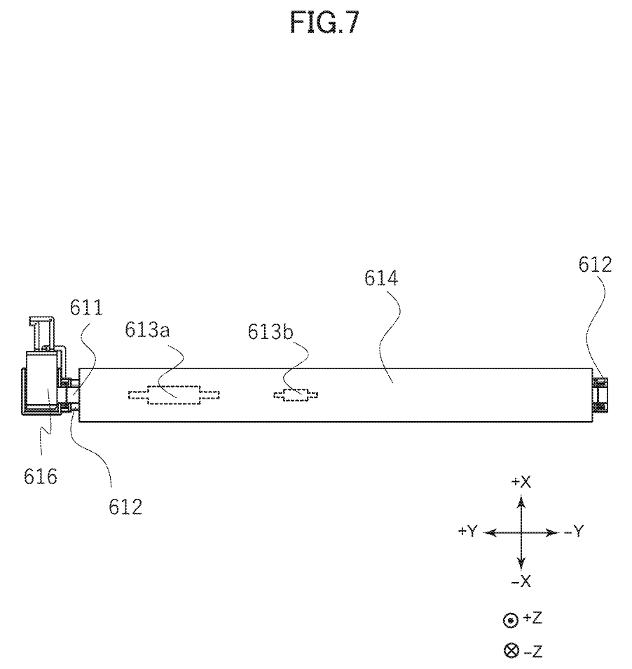

FIG. 7 is a bottom view illustrating the heater 611, the holder 612, and the belt 614. As illustrated in FIGS. 4 and 7, the holder 612 extends in the longitudinal direction (Y directing) through an interior of the belt 614, and both the end portions in the longitudinal direction project outwardly from the belt 614. The holder 612 supports the heater 611, and a connector 616, serving as a power supply connector to supply electrical power to the heater 611 and clamp the heater 611 and the holder 612, is disposed on one side of end portions in longitudinal direction of the heater 611.

To be noted, in this Example, the pressurizing rotary member 62 includes the shaft 62a and the roller 62b; however, it is not limited to this. For example, instead of the pressurizing rotary member 62, it is acceptable to apply a pressure belt that is pressed against the belt 614 of the heating unit 61.

### Heater

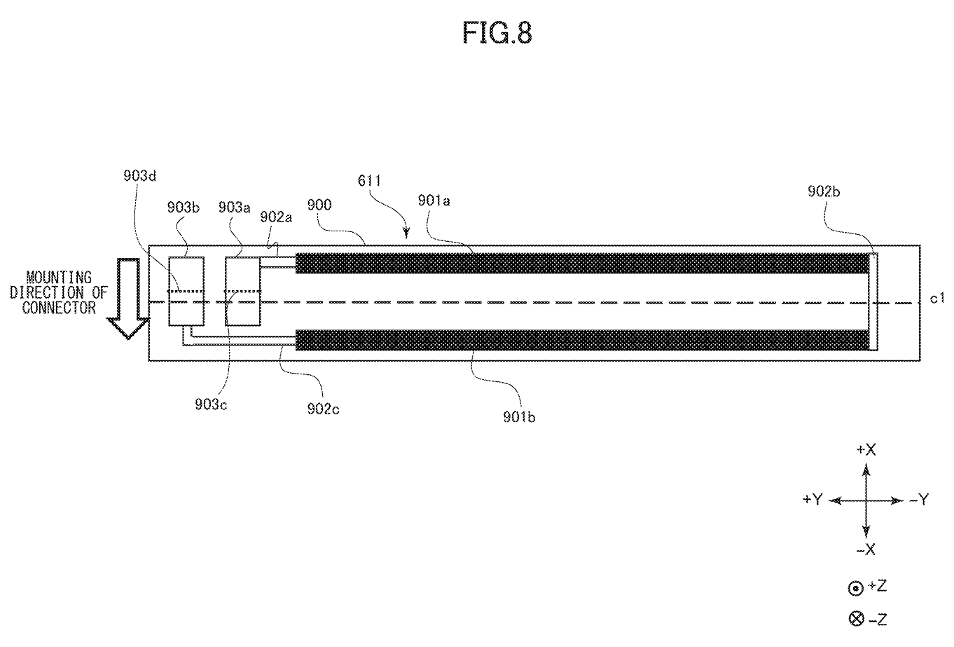

FIG. 8 is a bottom view illustrating the heater 611. As illustrated in FIG. 8, the heater 611 includes a plate shaped substrate 900 extending in the longitudinal direction (Y direction), and heating resistors 901a and 901b that are mounted on the substrate 900 and are disposed along the longitudinal direction. Conductors 902a to 902c are connected to both end portions in the longitudinal direction of the two heating resistors 901a and 901b.

A first end of the conductor 902a is connected to an electrode 903a for the heating resistor, and a second end of the conductor 902a is connected to the heating resistor 901a. A first end of the conductor 902b is connected to the heating resistor 901a, and a second end of the conductor 902b is connected to the heating resistor 901b. A first end of the conductor 902c is connected to the heating resistor 901b, and a second end of the conductor 902c is connected to an electrode 903b for the heating resistor. That is, the electrodes 903a and 903b are electrically connected to the heating resistors 901a and 901b. Therefore, by passing an electric current between the electrodes 903a and 903b, a heater circuit configuration is established in which the heating resistors 901a and 901b simultaneously generate heat.

Here, a center line in a short direction (X direction) of the electrode 903a is referred to as a center line 903c, a center line in the short direction (X direction) of the electrode 903b is referred to as a center line 903d, and a center line in the short direction (X direction) of the heater 611 is referred to as a center line c1. At this time, the center lines 903c and 903d of the electrodes 903a and 903b are located further upstream in a mounting direction (-X direction) of the connector 616 than the center line c1 of the heater 611. To be noted, it suffices if not both, but at least one of the center lines 903c and 903d of the electrodes 903a and 903b is located further upstream in the mounting direction (-X direction) of the connector 616 than the center line c1. The center line 903c is an example of a first center line, and the center line c1 is an example of a second center line.

### Connector

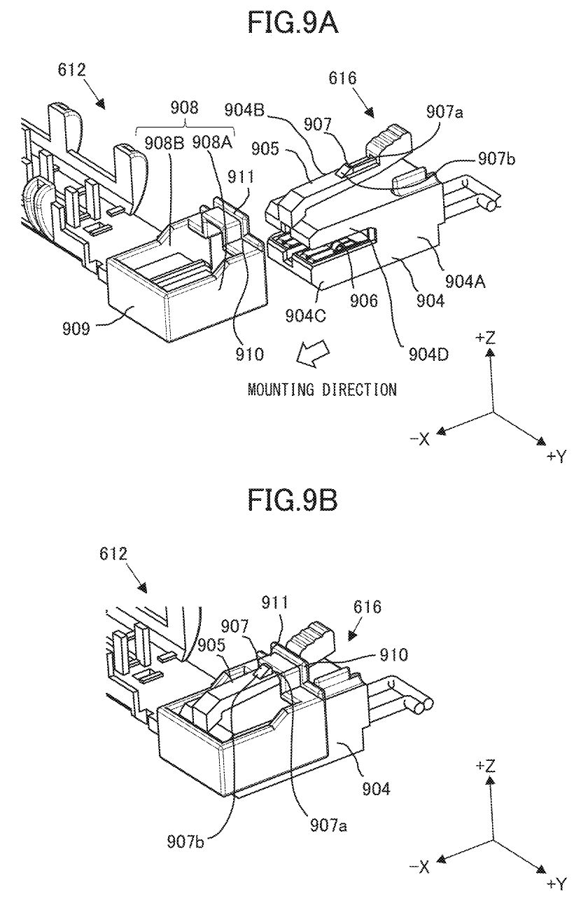

FIG. 9A is a perspective view illustrating a state immediately before the connector 616 is mounted into the holder 612, and FIG. 9B is a perspective view illustrating a state in which the connector 616 has been mounted into the holder 612. As illustrated in FIG. 9A, the connector 616 is mounted into a first end portion in the +Y direction of the holder 612 in a direction from one side in the short direction (X direction) of the heater 611 toward the other side. That is, the connector 616 is mounted with respect to the holder 612 in the -X direction. A width direction of the connector 616 is the same direction as the longitudinal direction of the heater 611 in a state in which the connector 616 is mounted into the holder 612, that is, the Y direction.

The connector 616 includes a housing 904 and an arm portion 905, each fabricated from non-electrically conductive materials such as resin, and a contact 906 formed from electrically conductive materials such as metal. A claw portion 907 is attached to the arm portion 905.

As illustrate in FIG. 9B, the housing 904 has a configuration that clamps first ends in the longitudinal direction (Y direction) of the holder 612 and the heater 611 in the state in which the connector 616 is mounted into the holder 612. The housing 904 includes a first side surface 904A and a second side surface 904B that extend so as to intersect the Y direction, and first extension portions 904C and second extension portions 904D that extend in the -X direction from each of the first and second side surfaces 904A and 904B toward the heater 611.

As illustrated in FIGS. 9A and 9B, the arm portion 905 is positioned downstream of the housing 904 in the +Z direction, which is a direction perpendicular to the mounting direction (-X direction) of the connector 616, and extends in the mounting direction (-X direction) of the connector 616. The arm portion 905 is disposed near the center of the connector 616 in the width direction (Y direction) of the connector 616. The arm portion 905 is configured such that a first end in the mounting direction is connected to the housing 904, and a second end is configured to elastically bend in a direction approaching the housing 904.

As illustrated in FIGS. 9A and 9B, the claw portion 907 is formed near the center in a mounting direction (-X direction) of the arm portion 905 so as to project in a direction away from the housing 904. The claw portion 907 includes an upright surface 907a that rises in the +Z direction so as to be positioned away from the housing 904, and an inclined surface 907b disposed downstream in the -X direction of the upright surface 907a. The inclined surface 907b is formed so as to approach the arm portion 905 as it extends in the -X direction, which is the mounting direction of the connector 616.

### Wall Portion of Holder

The holder 612 further includes a pair of wall portions 908, a connecting wall portion 909, and a connecting portion 910 connecting the pair of wall portions 908. The pair of wall portions 908, the connecting wall portion 909, and the connecting portion 910 are integrally formed at the end portion in the +Y direction of the holder 612.

The pair of wall portions 908 are a pair of walls that face each other in the Y direction, which is a direction perpendicular to the mounting direction (-X direction) of the connector 616. The pair of wall portions 908 are disposed so as to clamp the connector 616 therebetween in the state in which the connector 616 is mounted into the holder 612. In the longitudinal direction (Y direction) of the heater 611, the spacing between the pair of wall portions 908 is slightly larger than the length of the connector in the width direction (Y direction). The pair of wall portions 908 are constituted by a wall portion 908A, serving as a first wall portion, and a wall portion 908B, serving as a second wall portion that is arranged downstream in the -Y direction of the wall portion 908A. In the state in which the connector 616 is mounted into the holder 612, the wall portion 908A faces the first side surface 904A of the housing 904, and the wall portion 908B faces the second side surface 904B of the housing 904.

The connecting wall portion 909 is a wall that connects downstream end portions in the mounting direction (-X direction) of the pair of wall portions 908 (908A, 908B).

The connection portion 910 is disposed to connect upstream end portions in the mounting direction (-X direction) of the pair of wall portions 908 to each other. In addition, near the center in the Y direction of the connecting portion 910, a retention portion 911, serving as a retaining means for preventing the detachment of the connector 616, is disposed. That is, the retention portion 911, serving as a first retention portion, is integrally formed in the holder 612.

As illustrated in FIG. 9B, when the connector 616 is mounted into the holder 612, the arm portion 905 elastically bends so as to approach the housing 904. At this time, the inclined surface 907b of the claw portion 907, which is disposed on the arm portion 905, slidably engages a lower surface of the connecting portion 910. Then, when the connector 616 is mounted into the holder 612, the arm portion 905 elastically returns, and the claw portion 907 comes into contact with the retention portion 911 of the holder 612. At this time, when engaged with the upright surface 907a of the claw portion 907, the retention portion 911 restricts the movement of the connector 616 toward the upstream side in the mounting direction, that is, in the +X direction.

In addition, the housing 904 is brought into a state in which the first and second extension portions 904C and 904D respectively clamp the first end portions in the longitudinal direction of the heater 611 and the holder 612 via the contact 906.

When detaching the connector 616 from the holder 612, a worker applies pressure downward to elastically deform the arm portion 905. Thereby, the engagement between the upright surface 907a of the claw portion 907 with the retention portion 911 is released, and it becomes possible to move the connector 616 in a detachment direction (+X direction), which is opposite to the mounting direction. Thereby, the connector 616 can be detached from the holder 612.

### Description of Rectangular One-side Open Contact

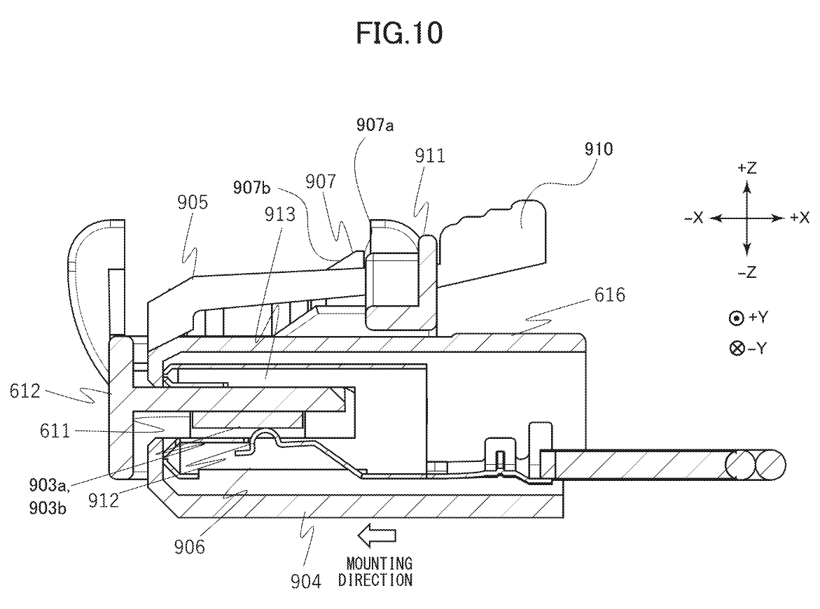

FIG. 10 is a cross-sectional view illustrating a cross-section taken along a plane perpendicular to the Y direction of the contact 906. As illustrated in FIG. 10, in the interior of the connector 616, the contact 906 has a rectangular shape that is open on one side( rectangular U-shaped cross section) when viewed in the longitudinal direction. The contact 906 includes surfaces, namely a spring pressure surface 912, serving as a first portion, and a pressure receiving surface 913, serving as a second portion, which are configured to face each other in the Z direction.

The spring pressure surface 912 is arranged downstream in the -Z direction of the pressure receiving surface 913, and, with spring pressure, comes into contact with the electrodes 903a and 903b for the heating resistors of the heater 611. In addition, the pressure receiving surface 913 is configured to receive pressure, which the spring pressure surface 912 applies to the heater 611, via the holder 612. In other words, the contact 906 is configured to clamp the heater 611 and the holder 612 between the spring pressure surface 912 and the pressure receiving surface 913, and, with this configuration, positions of the contact 906 and the holder 612 are secured so as not to be displaced even when subjected to external disturbances. In addition, the spring pressure surface 912 and the pressure receiving surface 913 are integrally formed as a single member, and the contact 906 has a rectangular shape that is open on one side when viewed in the longitudinal direction.

### Effects of Example 1

According to Example 1 described above, it is possible to secure positional relationships among the contact 906, the housing 904 of the connector 616, and the holder 612. The positional relationship between the housing 904 and the holder 612 is secured when the claw portion 907 and the retention portion 911 are engaged. The positional relationship between the contact 906 and the holder 612 is secured through a configuration in which the heater 611 and the holder 612 are clamped between the spring pressure surface 912 and the pressure receiving surface 913, which is integrally formed with the spring pressure surface 912, of the contact 906 having the rectangular shape that is open on one side. By configuring as described above, it is possible to prevent the contact 906 from being readily disengaged from the holder 612.

In addition, in a case where the connector 616 is displaced with respect to the heater 611, there is a risk that the spring pressure surface 912 of the contact 906 may be disengaged from the electrodes 903a and 903b. However, according to Example 1, with respect to the short direction (X direction) of the heater 611, the center line 903c of the electrode 903a and the center line 903 of the electrode 903b are positioned further upstream in the mounting direction (-X direction) of the connector 616 than the center line c1 of the heater 611. In addition, since the claw portion 907 is engaged with the retention portion 911, the displacement of the connector 616 with respect to the heater 611 upstream in the mounting direction (-X direction) of the connector 616 is restricted. Therefore, it is possible to suppress the disengagement of the spring pressure surface 912 of the contact 906 from the electrodes 903a and 903b. Further, the displacement of the connector 616 with respect the heater 611 downstream in the mounting direction of the connector 616 is restricted by the connecting wall portion 909 of the holder 612. Therefore, it is possible to suppress the disengagement of the spring pressure surface 912 of the contact 906 from the electrodes 903a and 903b.

To be noted, in cases where the holder 612 and the retention portion 911 are not integrally molded but are instead formed as separate members, and the holder 612 and the retention portion 911 are to be engaged, there exists the possibility that the positions of the holder 612 and the retention portion 911 may become misaligned. Since the connector 616 is engaged with the retention portion 911, in a case where the positions of the holder 612 and the retention portion 911 are misaligned, the positions of the connector 616 and the holder 612 are misaligned. As a result, the contact positions between the spring pressure surface 912 and the electrodes 903a and 903b become misaligned. However, in the fixing unit 6 in this Example, the holder 612 and the retention portion 911 are integrally formed. Thereby, it is possible to reduce effects of deviations in the contact positions between the spring pressure surface 912 and the electrodes 903a and 903b caused by the misalignment of the holder 612 and the retention portion 911 described above.

### Example 2

While, next, Example 2 of this disclosure will be described, Example 2 differs from Example 1 in that a retention portion 917 and a projecting portion 914 are respectively added to the housing 904 and the contact 906 of Example 1. Accordingly, configurations similar to those in Example will be omitted from illustration, or will be described by putting the same reference characters in drawings.

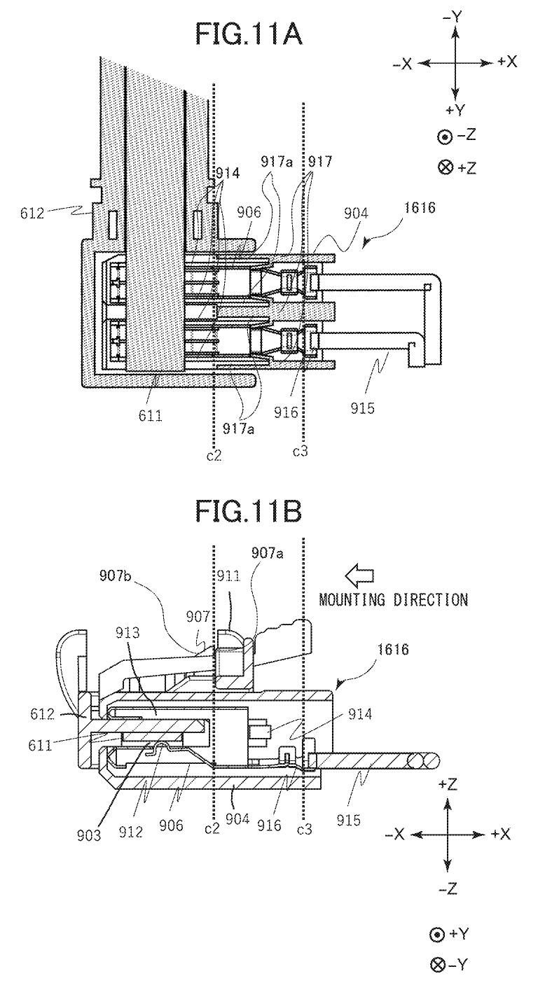

FIG. 11A is a cross-sectional view illustrating a cross-section taken along a plane perpendicular to the Z direction of the holder 612 and the contact 906. FIG. 11B is a cross-sectional view illustrating a cross-section taken along a plane perpendicular to the Y direction of the holder 612 and the contact 906. As illustrated in FIGS. 11A and 11B, the contact 906 of a connector 1616, serving as a power supply connector according to Example 2, is mounted into the housing 904 after crimping a power supply cable 915 with a crimping portion 916. In the housing 904, the retention portion 917, serving as a second retention portion, is disposed, and a plurality (in this Example, four) of grooves 917a are formed in the retention portion 917.

A plurality (in this Example, four) of projecting portions 914 capable of engaging with the plurality of grooves 917a of the retention portion 917 are disposed on the contact 906. When the projecting portions 914 of the contact 906 engage with the grooves 917a of the retention portion 917, the detachment of the contact 906 with respect to the housing 904 in a detachment direction (+X direction) opposite to the mounting direction (-X direction) is suppressed after the contact 906 is mounted into the housing 904. The projecting portions 914 are disposed at substantially the central portion in the Z direction of the contact 906 so as to prevent the contact 906 from tilting within the interior of the housing 904. In addition, the grooves 917a of the retention portion 917 and the projecting portions 914 extend in the X direction, and engage with each other also in the Y direction. Therefore, also the position in the Y direction of the contact 906 with respect to the housing 904 is determined. To be noted, while, in this Example, four groves of the retention portion 917 and four projecting portions are disposed, it is not limited to this. For example, the number of each of the grooves 917a and the projecting portions 914 may be one to three or equal to more than five.

In addition, to miniaturize the connector 1616, the retention portion 917 is arranged further upstream in the mounting direction (-X direction) than a portion, indicated by a line c2, at which the claw portion 907 and the retention portion 911 are in engagement. In other words, when the connector 1616 is viewed in the longitudinal direction (Y direction) in a state of being mounted into the holder 612, the retention portion 917 is positioned further upstream in the mounting direction (-X direction) than the retention portion 911. Further, if the contact 906 is extended upstream in the mounting direction (-X direction) beyond what is necessary, it leads to an increase in the size of the contact 906. Therefore, the projecting portions 914 of the contact 906 are preferably arranged further downstream in the mounting direction (-X direction) than the crimping portion 916, indicated by a line c3, crimping the power supply cable 915.

### Effects of Example 2

According to Example 2 described above, when the retention portion 917 of the housing 904 and the projecting portions 914 of the contact 906 are engaged, the contact 906, which is mounted into the housing 904 of the connector 1616, is secured with respect to the housing 904. Therefore, the positional relationships among the contact 906, the housing 904, and the holder 612 can be more firmly secured than in Example 1.

### Other Embodiments

To be noted, while, in Examples described above, the second surface 611b of the heater 611 directly comes into contact with the inner circumferential surface of the belt 614, it is not limited to this. For example, the heater 611 may come into contact with the inner circumferential surface of the belt 614 via a sheet material having high thermal conductivity, such as an iron alloy or aluminum. Even if such a sheet material is disposed between the heater 611 and the belt 614, the pressurizing rotary member 62 clamps the belt 614 together with the heater 611.

In addition, while, in Examples described above, the belt 614 is disposed in the heating unit 61, an endless film may be applied instead of the belt 614. In addition, the fixing unit 6 may be configured such that the heating unit 61 applies pressure with respect to the pressurizing rotary member 62, or, alternatively, the pressurizing rotary member 62 applies pressure with respect to the heating unit 61.

According to this disclosure, it is possible to provide a new configuration of the fixing unit that advances conventional technology.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2024-224574, filed December 19, 2024, which is hereby incorporated by reference herein in its entirety.

What is claimed is:

1. A fixing unit comprising:
a fixing belt which is tubular;
a heater including:
a substrate having a plate shape;
a heating resistor disposed on the substrate; and
an electrode electrically connected to the heating resistor and disposed at an end portion in a longitudinal direction of the substrate, the heater being disposed within an inner space of the fixing belt;
a holder disposed within the inner space of the fixing belt and configured to hold the heater along the longitudinal direction thereof; and
a power supply connector configured to supply electrical power to the heater, the power supply connector including:
a contact configured to come into contact with the electrode, the contact having conductivity; and
a housing configured to accommodate the contact,
wherein the fixing unit is configured to fix a toner image formed on a recording material onto the recording material with heat of the heater via the fixing belt,
wherein the holder is integrally formed with a retention portion configured to prevent the power supply connector from disengaging from the heater,
wherein the contact includes:
a first portion configured to come into contact with the electrode; and
a second portion configured to clamp the heater and the holder in conjunction with the first portion, and
wherein, when viewed in the longitudinal direction, the contact has a rectangular shape that is open on one side.

2. The fixing unit according to claim 1, wherein the housing includes a first side surface and a second side surface that intersect the longitudinal direction,
wherein the holder includes a first wall portion facing the first side surface and a second wall portion facing the second side surface, and
wherein, when the power supply connector is mounted into the holder, the power supply connector is positioned between the first wall portion and the second wall portion of the holder.

3. The fixing unit according to claim 2, wherein the holder includes a connecting portion that connects the first wall portion and the second wall portion, and on which the retention portion is provided.

4. The fixing unit according to claim 3, wherein, when the retention portion of the holder is referred to as a first retention portion, the housing includes a second retention portion configured to prevent the contact from disengaging from the housing toward an upstream side in a mounting direction of the power supply connector, and
wherein, when the power supply connector is mounted into the holder and viewed in the longitudinal direction, the second retention portion is positioned further upstream in the mounting direction than the first retention portion.

5. The fixing unit according to claim 4, wherein the contact is provided with a crimping portion configured to crimp a power supply cable connected to the contact, and
wherein the second retention portion is positioned further downstream in the mounting direction of the power supply connector than the crimping portion.

6. The fixing unit according to claim 1, wherein the heater is configured such that a first center line in a short direction of the electrode is positioned further upstream than a second center line in a short direction of the substrate in a mounting direction of the power supply connector.
